(19) United States
(12) Patent Application Publication
(10) Pub. No.: US 2008/0298593 A1
(43) Pub. Date: Dec. 4, 2008

(54) Gateway Shared Key

(75) Inventor: Li Shen, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/755,524

(22) Filed: May 30, 2007

(51) Int. Cl. H04L 9/14

(52) U.S. Cl. 380/278

(57) ABSTRACT

Procedures for using common encrypt/decrypt keys are described. In an example, a scale key is generated for encrypting host media stream for more than one client. The scale key may be exchanged with a first client so that the host receives a first client key for decrypting a first client media stream. The host may send a gateway device the scale key such that the gateway device may use the scale key. In implementations, the host may receive a share key for decrypting end client media stream forwarded through the gateway device.

### BACKGROUND

Multipoint conferencing is increasingly popular as remote participants may join in common meetings. Clients or participants may exchange audio, video, and/or other content with a common host which in-turn may provide other clients the audio/video content from the other clients.

Take for example a three client meeting. At inception; the clients may establish a connection with a common host for passing audio and video content. While a host may be dedicated to this particular conference, in some instances, the host may function as an intermediary for other unrelated media sessions. In various cases, the participants may desire to prevent unauthorized clients from accessing data. Thus, the participants may use a “key” in conjunction with an encryption algorithm.

Returning to the example meeting, if the first client sends media content to the host, the host may decrypt the media content with a key and then encrypt the media content for the other clients (e.g., encrypt content using a second key for a second client and encrypt the content using a third key for the third client). While this technique limits content access, the host may face a significant memory and processing burden as the processing overhead for encrypting the content streams increases with the number of clients.

Additionally, some clients may have limited functionality. For example, some participants may use a telephone (e.g., that can send/receive audio) rather than audio, video and/or other media, such as “white board’ media, and so on. The foregoing devices may not have the functionality to encrypt/decrypt communications.

### SUMMARY

Procedures for using common encrypt/decrypt keys are described. In an example, a scale key is generated for encrypting host media stream for more than one client. The scale key may be exchanged with a first client so that the host receives a first client key for decrypting a first client media stream. The host may send a gateway device the scale key such that the gateway device may use the scale key. In implementations, the host may receive a share key for decrypting end client media stream forwarded through the gateway device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an environment in an exemplary implementation that may use technologies to minimize multimedia host send data stream encryption.

FIG. 2 is a flow diagram depicting a procedure in an exemplary implementation for establishing scale key encryption.

FIG. 3 is a flow diagram depicting a procedure in an exemplary implementation for multiple client scale key encryption.

### DETAILED DESCRIPTION

Overview

Accordingly, techniques are described to use scale key encryption/decryption for minimizing media host processing overhead. A key may be a code or series of characters which when implemented with an encryption algorithm make the information unintelligible or understandable as desired. In one or more implementations, systems are discussed in which a scale key (a key which may be used for more than one client). Using the scale key with more than one client may reduce the burden on the host in encrypting media for those clients. For example, a scale key is used for encrypting a host multimedia send stream (e.g., a stream including audio and video) for first and second clients. In this way, the host may service multiple clients while minimizing the processing and memory burden associated with encrypting the media stream for individual clients.

In further implementations, a gateway device may be included for handling media client media flowing between audio clients and the host. Thus, the gateway device may bridge between a private branch exchange (PBX) gateway and the host. In further implementations the gateway device may act as a PBX or a public switched telephone network (PSTN) gateway so that data may flow through the gateway device and to the host. For example, a gateway device may encrypt/decrypt data streams (flowing between the gateway device and the host) for one or more voice over internet protocol (VoIP) clients. Thus, session encryption security may be maintained, between the host and the gateway device, while permitting participation by multiple VoIP devices. In addition, a common share key may be used for encrypting end client media streams routed between the gateway device and the host. For example, a common share may be used for encrypting/decrypting publicly switched telephones (PST) data flows between the gateway device and the host, such as an intermediary in a VoIP session. In instances, the gateway device may encrypt audio client data via the share key for transfer to the host.

In implementations, techniques are described in which a scale key may be used for two or more clients. The established scale key may be used for other clients, when adding session or conference clients. The procedures may minimize the host processing/memory burden by establishing common encrypt/decrypt keys among various clients.

Exemplary Environment

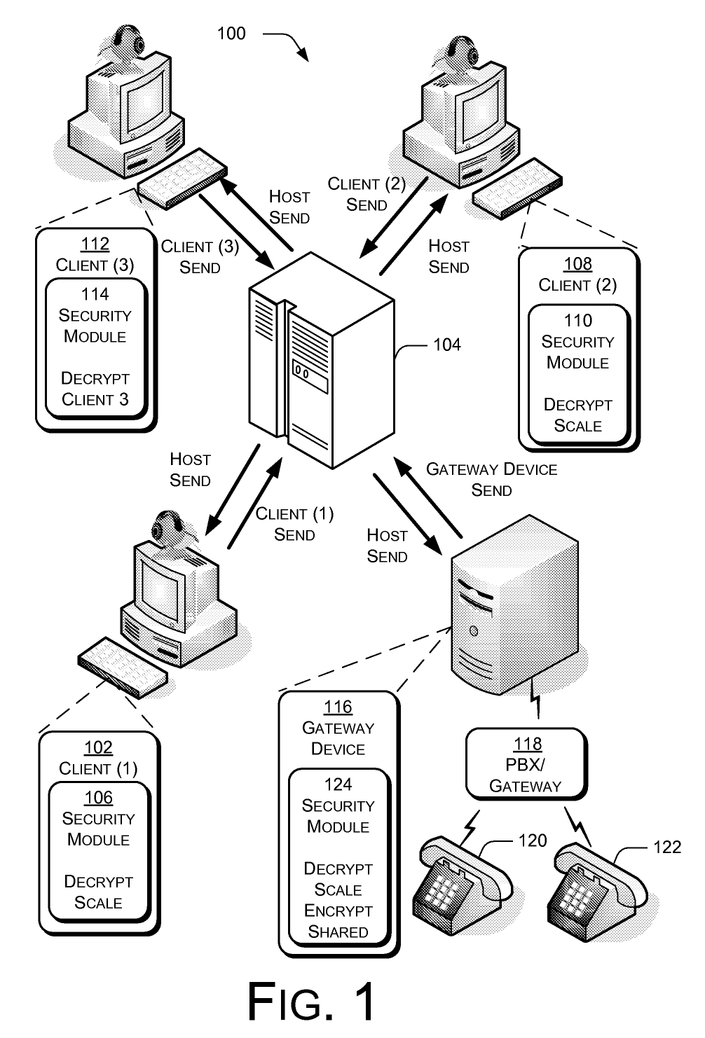

FIG. 1 illustrates environment 100 in exemplary implementations that are operable to use scale key host encryption for minimizing host resource consumption. For example, a switching server may encrypt host media streams (i.e., client streams passed through the host 104) using a scale key for more than one client. Using a scale key may reduce the memory and central processing unit (CPU) load in comparison to situations employing separate client encryption keys for the host media streams. For example, in addition to passing/mixing various client input audio/video streams, the switching server may encrypt host media streams (e.g., client generated media streams passed through the host 104 for other client consumption) so that the media content is unintelligible to unauthorized parties.

For a media conference, the meeting may commence with a first client 102 initiating the meeting with the host 104, such as an audio/video switching server or a intermediate device in a VoIP conference. The host 104 may accept various client media inputs for distribution to other clients. For example, a first client 102 is a personal computer with an associated webcam and audio microphone device. While the host 104 is discussed with respect to a meeting among clients, in some instances, the host 104 may function in a similar capacity for other unrelated sessions. Other suitable client devices may include, but are not limited to, dedicated web conferencing systems, laptops, video phones, publicly switched telephones, VoIP phones, and so on.

While the first client 102 and the host 104 may initialize communication using a variety of protocols, for the present discussion, the components may establish the communication using session initiated protocol (SIP). SIP generally may be used to establish, modify or terminate media communication sessions. For example, SIP procedures may be used to locate the client terminal and exchange configuration information. SIP procedures may implement session description protocol (SDP) for establishing communication. The resultant conference (e.g., the media content streams carrying the audio/video information) may be secured using secure real-time transport protocol (SRTP) and so on. For instance, the first client 102 and the host 104 may establish a session in a SIP compliant fashion and designate media transport in a SRTP compliant manner. Thus, the scale key and client keys may be SRTP compliant as the keys secure media transports. Additional clients may be added in a similar manner, and the session may be terminated using SIP procedures.

During initiation, if security is desired, the first client 102 may forward the host 104 a client key for decrypting the first client 102 media stream. For example, while establishing the session, the first client 102 may send the host 104 a client encryption key for symmetric encryption/decryption. Additional data may be included for aiding encryption/decryption and so on. With the client encryption key, the host 104 may decrypt the first client media stream. For example, the host 104 decrypts the first client media stream so the audio/video may be included in the audio/video conference (e.g., the host media stream).

Additionally, the client may send the host 104 other client parameters as desired. For example, a first client security module 106 may specify operating parameters, client identifiers and other configuration information and so on. In this manner, the host 104 may accommodate the first client security module 106.

In response to the first client initiating a conference, the host 104 may generate a scale key. For example, the host 104 may generate a scale key based on client parameters and so on. For example, the first client 102 may specify that the client is configured to receive scale encrypted media. The host 104 may exchange the scale key with the first client. The first client 102 may use the scale key to decrypt the host media streams. For example, when multiple clients are included in the session, the host 104 may send the first client 102 a content stream including audio/video from the active participants (e.g., participants generating audio/video). In this situation, the host passes the active client stream(s) through to the various clients (the participants listening/watching media). Thus, for a multiple party conference, when communicating media content, the host 104 may decrypt the various client media streams and re-encrypt the audio/video content stream with the scale key. During the session, clients may identify the content is encrypted with the scale key by examining an encryption field included in the packet payload, the packet itself or other packet characteristics. For example, clients may determine a packet is encrypted with a scale key by examining characteristics of the data in the real-time protocol (RTP) packet.

In implementations, the first client may send to the host a (first) client key during initiation. For example, as part of the initiation request the first client may forward a client key. Additionally, the first client may indicate that the first client is capable of using a scale key. In further instances, the first client may send the client key in response to the host exchanging the scale key with the first client.

A second client 108, at the first client's request, may join the conference by accepting a SIP invitation. As part of the session offer, the host 104 may send the scale key (previously established with first client 102) with a request that the second client 108 acknowledge if the second client security module 110 supports the scale key. In further instance, the host may offer a non-scale key as well, if for instance the client does not support the scale key. For instance, the host may send the scale key and a SRTP key. This may be conducted as part of the initial signaling when establishing a session. For example, the scale key may be passed through the SDP procedures before media content is transmitted. In this manner, the host 104 may inform the second client 108 that the host 104 supports scale key encryption. In implementations, the second client may identify the scale key based on an included identifier in a scale key encrypted packet, such as an identifier at the beginning of the key.

If the second client 108 is capable of supporting the scale key, such as if encryption is enabled, the second client 108 may acknowledge the host invitation to join the conference and provide a second client key for decrypting audio/video input encrypted by the second client security module 110. If the second client does not support the scale key, the host may use a non-scale key. For example, if the second client does not recognize the scale key the other key may be used. Thus, when transmitting content, the host 104 may decrypt second client media stream with the second client key, while the host 104 encrypts host media flowing to the first 102 and second 108 clients with the scale key.

If, for example, a third client 112 attempts to join the session, the third client 112 may send the host 104 a client key for the third client 112. In further instances, the joining client (e.g., the third client) may send a (third) client key in response to the host sending the established scale key. Additionally, the host may send a non-scale key for use if encryption is on in the third client profile and the third client does not recognize the scale key. Additionally, the third client 112 may provide security module 114 parameters and so on. In response to the third client's request to join the conference, the host 104 may return the scale key established for the first 102 and second 108 clients. If the third client 112 supports the scale key, the host 104 may send the host media stream, encrypted with the scale key, to the first 102, second 108 and third 112 clients.

The third client 112 may not support the scale key, if for example, the third client security module 114 does not recognize the scale key or the encrypt/decrypt functionality has been “turned-off” or de-activated. The third client 112 may so notify the host 104. In this situation, the host 104 may encrypt the media stream with the scale key for the first and second clients while sending the third client 112 an unencrypted media stream. If encryption has been selected for the session, the host 104 may deny entry for a client which does not support encryption. For example, if the host policy specifies encryption, the third client may not be permitted to join the conference unless the third party supports the specified encryption.

Additional clients may be added in similar fashions as discussed above with respect to the first, second or third clients. Thus, the scale key may be used for a plurality of clients and may commensurately reduce the host 104 overhead associated with encrypting media streams for individual clients.

In further implementations, a gateway device 116 may be included between a PBX gateway 118, in communication with private branch exchange audio clients, and the host 104. Devices may include, but are not limited to, telephones (such as a first telephone 120 and a second telephone 122), private branch exchange (PBX) telephones, publicly switched telephones (PST), devices without encrypt/decrypt functionality such as video phones, VoIP phones, and so on. For instance, a PBX gateway 118 may connect remote VoIP clients with the gateway device 116.

Thus, the gateway device security module 124 may encrypt/decrypt media content from the individual telephones (such as the first telephone 120 and the second telephone 122) during communication with the host 104. For example, the gateway device may encrypt streams sent from the telephones 120 and/or 122 and forward the encrypted audio content to the host 104. Correspondingly, the gateway device may decrypt an host streams (e.g., a client stream forwarded through the host) and forward the content to an audio client (e.g., the phones 120 and/or 122). The gateway device 116 may connect via a SIP procedure through the host 104. Additionally, the gateway device 116 may support SRTP and/or SDP techniques. Other security protocols may be used as well. In this manner, a audio/video conference may be secured even though some of the client devices may not support encrypt/decrypt functionality (such as, the first telephone 120 and the second telephone 122). Thus, the gateway device 116 may support encrypt/decrypt functionality while some end devices may not. Additionally, the gateway device 116 may provide other services to the end client devices. Other security measures may be used for securing remote client/gateway device communication and access as desired.

The gateway device 116 may exchange keys in much the same manner as the clients discussed above. For example, the gateway device 116 may be asked to join the meeting, may request to join a meeting and so on. For example, the gateway device may request to join a meeting, if an end client (e.g., telephones 120 and/0 122) accesses the conference through the gateway device 116. For example, the gateway device may bridge between the PBX gateway 118 and the host 104. Thus, the gateway device may permit conference access to outside clients, audio clients, clients lacking encryption/decryption while preserving security within the conference.

While the gateway device 116 may support scale key decryption for host send streams, the gateway device 116 may establish a share key for the end client data flows occurring between the gateway device 116 and the host. For example, the gateway device may encrypt multiple client media streams flowing to the host 104 with a share key for devices lacking encrypt/decrypt functionality, while decrypting host send streams with the scale key. For example, if two VoIP telephones are included in a conference, (such as the first telephone 120 and the second telephone 122) the gateway device 116 may implement the share key for the telephone media streams passing to the host 104. Thus, when communicating client media streams (such as from the first and second telephones), the gateway device may encrypt the audio content with the share key, transferred to the host 104. In turn, the host may decrypt the stream with the share key. For example, the gateway device 116 may forward the host client media streams that were encrypted with the share key. Using a scale key when encrypting content between the host 104 and the gateway device may minimize host encryption overhead, as the scale key encrypted content may be used for multiple audio clients and the gateway device, with the gateway device decrypting the host streams. Correspondingly, when receiving a host audio steam (i.e., another client stream routed through the host 104) the gateway device may decrypt the media content and then pass the content on to the gateway and the audio client.

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

Exemplary Procedures

The following discussion describes methodologies that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. A variety of other examples are also contemplated.

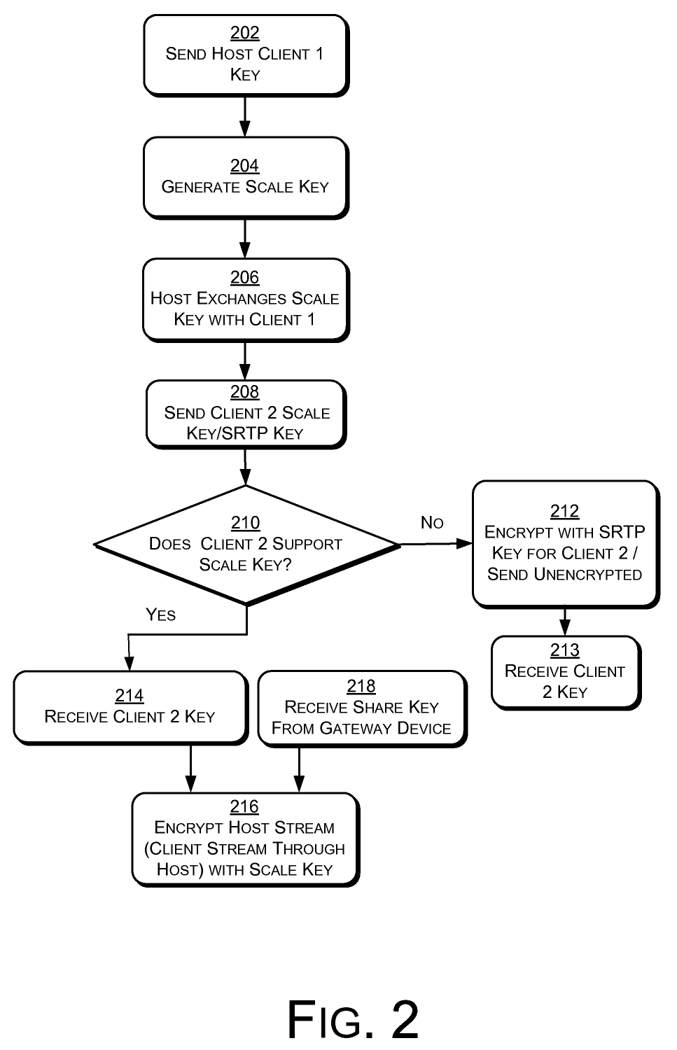

FIG. 2 discloses exemplary procedures for minimizing host encryption/decryption processing overhead. For example, common key encryption may minimize host (such as an AVMCU in a multimedia event or an intermediate device passing VoIP communications) encryption for various media stream packets. The procedures discussed herein may be used to share common keys among servers, such as, between a host and a gateway device.

In implementations, the instant techniques and procedures may be SIP compliant. For example, the techniques discussed herein may be used in conjunction with SIP signaling procedures for initializing a media conference.

In implementations, a first client may send 202 the host a client key for decrypting media packets included in a first client media stream. Additionally, the first client may send the host other security configuration information. For example, the client may notify the host if the client encryption functionality is active, and so on. Thus, the host may determine if a scale key should be used for this client. For example, the first client may send the client key as part of a SDP included in a SIP invite.

The host may generate 204 a scale key for encrypting/decrypting a host media stream. For example, the scale key is generated 204 for symmetrically encrypting/decrypting host media streams (e.g., the media passed through the host from the active clients) for multiple media clients. For example, during media content transport, the host implements the scale key with a corresponding algorithm so that the host audio/video stream (e.g., the active client media input) is unintelligible to unauthorized parties (e.g. those parties which do not have the scale key), while multiple authorized clients may be capable of decrypting the packets with the scale key and relevant algorithm.

In other implementations, the host may receive the client key as part of a key exchange 206 in which the host sends the client a host generated scale key for encrypting/decrypting host media streams and the client may send or return the host a client key for decrypting a client media stream. For example, the host may send a client a scale key which has been previously established with another client in response to a SIP invitation. In other instances, in response to a request to join a client (e.g., a SIP invitation), the host may send a scale key. If the client supports the scale key, the client may send the host a client key for decrypting a client media stream. In the foregoing situation, the client request may be from the client attempting to join the conference or from a current client requesting that the target client join the conference. The host may send a non-scale key for use if the client does not support the scale key. For example, a non-scale key may be used if encryption is on in the client security profile, but the scale key is not recognized. The request may be conducted in a SIP compliant manner. The client may respond by indicating what encryption key the client supports.

The host may exchange 206 a scale key with the first client. For example, the host may return 206 the scale key to the client in response to the first client's participation request or to the host's reception of a client key.

For example, the host and clients may implement SDP when initiating, modifying or terminating a conference session, while SRTP is used to secure the content data packets. For example, the send, the scale and other keys for securing media content may be SRTP compliant. Other protocols are available as well.

Additional clients may be joined in similar fashions. For example, a second client may join by forwarding to the host a (second) client key. The host may respond by sending to the second client the scale key 208 (previously established for use with the first client). In other situations, the client may exchange keys (e.g., the scale and relevant client key) as part of the host sending the scale key 208. Additional information may be transmitted as well. For example, if the second client security module is encryption enabled, and so on. If the second client does not support the scale key 210, the host may send to the second client an unencrypted version of the host media stream, if encryption is not supported, or the host may use a non-scale key for encrypting media content. For example, if the second client does not support the scale key or a “no” decision is reached, the host may send the media stream without encryption while encrypting 212 a host media stream for other clients or may use a non-scale SRTP key. While the client may receive an unencrypted stream or a stream encrypted with a non-scale SRTP key, the second client may send 213 the host a second client key for decrypting second client send streams. If the decision is reached that the second client does support the scale key or a “yes” decision is obtained, the host may receive 214 the (second) client key, if the client key has not yet been sent to the host. Thus, upon generating a host media stream (forwarding a client media input), the host may encrypt 216 the host media stream for the first and second client with the scale key. For example, if a first client is speaking, the host media stream is the host forwarded first client audio.

In implementations, if the clients lack encrypt/decrypt functionality, are external clients (such as VoIP clients), and so on, a gateway device may use a share key for encrypting the end client data streams passing between the gateway device and the host. For example, if VoIP phones are used, a gateway device and the host may implement a common share key for content passed from the gateway device to the host. Thus, the various client media streams are encrypted/decrypted using the share key, while the host media stream is encrypted/decrypted with the scale key. Put another way, the host may receive 218 a share key from the gateway device for decrypting end client media streams encrypted by the gateway device as the client media is forwarded to the host. The gateway device and/or the gateway device's clients, may join a media conference in substantially similar manners as discussed with respect to the clients above. For example, the gateway device may request to join a session (such as on behalf of an end client), be asked to join by an existing client (for gaining access to an end client such as a VoIP participant) and the like.

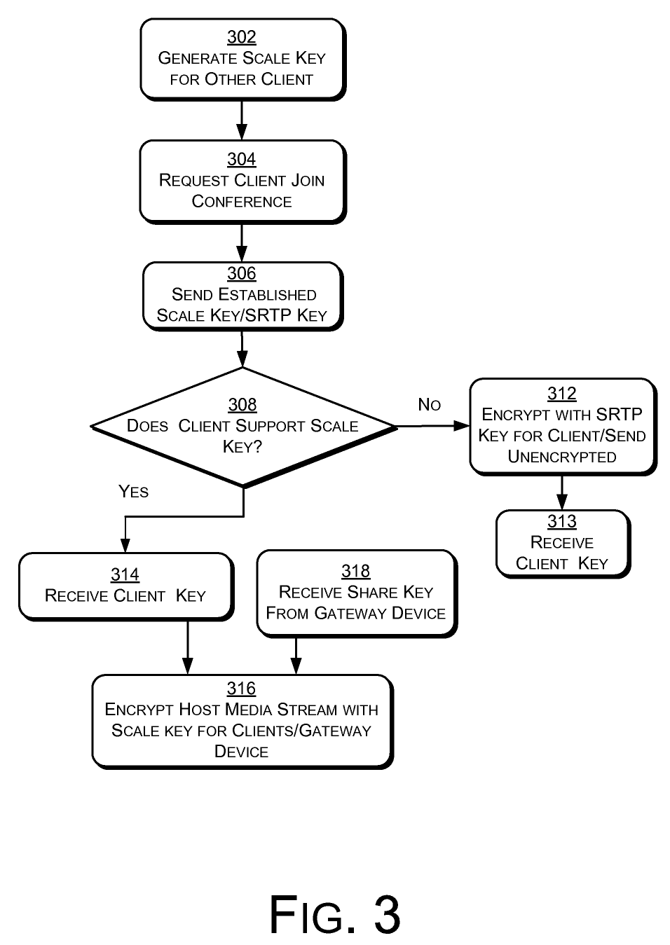

FIG. 3 discloses exemplary procedures for supporting multiple client scale keys. The procedures may minimize the host's encryption burden in a secure environment. For example, common keys may be used for encrypting media communications. In this manner, encryption processing may be reduced in comparison to client-specific encryption.

A scale key may be previously generated 302 for other clients (such as a previous, or a first client). For example, the host may have generated and exchanged a scale key with another client prior to a second client requesting admission to the conference. In response to a client request 304 to join a multimedia conference, the host may send 306 the client an established scale key for decrypting the host media streams. For example, the key may have been previously established with a first client by exchanging the scale key between the host and first client. In further instances, the host/first client may have used the scale key for encrypting/decrypting other client media content forwarded through the host. In further instances, the host may send a client specific key for use if the client does not support the scale key. For example, the host may send the client a SRTP key and the scale key so that if the client does not support the scale key, then the client may use the SRTP key if client encryption/decryption is available.

For example, the procedures discussed herein may be used in conjunction with SIP initialization procedures. In implementations, an intermediary server may be included in gateway device SIP signaling while media transport is passed between the gateway device and a host clients. Other initialization protocols may be used as desired. For example, a multimedia (e.g., an audio/video) client, seeking conference admission, may be sent 306 the scale key, and SRTP key) which may encrypt/decrypt host media streams for one or more other clients. For instance, the scale key may be common to a first client and a second client. Thus, as discussed below, when transferring content, a host may decrypt incoming client media streams, perform desired switching or packet directing, encrypt the data packets underlying the content with the scale key and forward the content. At the client end, the clients may use a designated algorithm and decrypt the content packets with the scale key. For audio clients, the gateway device may encrypt/decrypt the content packets. In this fashion, communications between the host and the gateway device are secured. Communications between the gateway device and the end client may be unencrypted. As noted previously, the keys may be SRTP compliant with the keys being exchanged between the host and gateway device in a SDP compliant manner (before forwarding to the audio clients).

The suitability of the scale key may be determined 308. For example, does the client support the scale key 308? For example, the client may verify that the scale key is supported by examining the characteristics associated with scale key and so on.

In other examples, if the client affirmatively supports the scale key (or the yes branch) the host may encrypt a host media stream with the scale key for the other (first) client and the joining (second) client. For example, the host may encrypt a host media stream from another client media input using the scale key. If, in contrast, the second client does not support the scale key (or the “no” branch decision is reached), the host media stream may be unencrypted or encrypted with a non-scale key (e.g., a client specific key). Thus, while the scale key may be used to encrypt 312 the content for the other client (e.g., a first client), the second client may receive an unencrypted media stream or a media stream encrypted with a client specific key. The client may send 313 the host a (second) client key for decrypting second client send streams. In the latter instance, a client specific key may be used if the client security module is active but the client does not support the scale key. The client may not support scale key encryption if, for example, the feature has been disabled within a client security module and so on. These procedures may be performed in conjunction with the SIP procedures as desired.

The host may receive 314 a client key from the (second) client. For example, the second client acknowledges scale key support by returning the host the second client key. The client may send additional information encryption/decryption information as well.

Thus, for a host media stream generated from client media input, the host may encrypt 316 the media stream for the first and second clients, if the first and second clients support the scale key.

In further implementations, the host may receive 318 a share key from a gateway device (joined in a similar fashion as the second client above) for decrypting one or more audio client media streams for external clients, clients lacking encrypt/decrypt functionality and so on encrypted by the gateway device. For example, a PBX gateway may connect the end clients (such as VoIP telephones) with the gateway device. While the gateway device may join in a similar fashion to client, as discussed previously, the gateway device may return the host a share key for decrypting the gateway device encrypted various audio client media streams. The conference may be secure while some client devices may not support encrypt/decrypt. For example, an unencrypted end audio client stream may be encrypted by the gateway device using the share key and transferred to the host. In this manner, the gateway device may act as an intermediary between a PBX gateway and the host and secure communications between the host and the gateway device.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
generating a scale key for encrypting a host media stream for more than one media client;
exchanging the scale key with a first media client and receiving a first client key for decrypting a first client media stream;
sending a gateway device the scale key;
receiving a share key for decrypting a gateway device media stream from at least one end client.

2. The method as described in claim 1, further comprising encrypting a host media stream with the scale key for the first media client and the gateway device.

3. The method as described in claim 1, wherein a host generates the scale key.

4. The method as described in claim 1, wherein the method is session initiated protocol (SIP) compliant.

5. The method as described in claim 1, wherein the at least one end client is a public switched telephone network (PSTN) telephone.

6. The method as described in claim 1, wherein the gateway device media stream is voice over internet protocol (VoIP) media.

7. The method as described in claim 1, wherein the scale key includes a characteristic which identifies the scale key.

8. The method as described in claim 1, wherein the method is session description protocol (SDP) compliant.

9. The method as described in claim 1, wherein the scale key is secure real-time transport protocol (SRTP) compliant.

10. One or more computer-readable media comprising computer-executable instructions that, when executed, direct a computing system to,
in response to a request to join an end client to media session, send a gateway device an established scale key for decrypting a host media stream;
receive a share key for decrypting an end client media stream forwarded through the gateway device.

11. The one or more computer-readable media as described in claim 10, wherein the session is a voice over internet protocol (VoIP) session.

12. The one or more computer-readable media as described in claim 10, wherein the scale key is sent in a session description protocol (SDP) compliant manner.

13. The one or more computer-readable media as described in claim 10, wherein a host generates the scale key.

14. The one or more computer-readable media as described in claim 10, wherein the scale key is secure real time transport protocol (SRTP) compliant.

15. A system comprising:
a switching server for generating send media stream from client media stream, the switching server encrypting the send media stream with a scale key for more than one client; and
a gateway device for transferring a plurality of end client input media streams encrypted with a common share key.

16. The system as described in claim 15, wherein an end client is a public switched telephone network (PSTN) telephone.

17. The system as described in claim 16, wherein the share key is secure real time transport protocol (SRTP) compliant.

18. The system as described in claim 16, further comprising a public switched telephone network (PSTN) gateway forwarding the gateway device a plurality of voice over internet protocol (VoIP) media stream.

19. The system as described in claim 15, wherein the switching server generates the scale key.

20. The system as described in claim 15, wherein the switching server is session description protocol (SDP) compliant.
